(19) United States
(12) Patent Application Publication
(10) Pub. No.: US 2013/0260834 A1
(43) Pub. Date: Oct. 3, 2013

(54) PROXIMITY DETECTION SYSTEM FOR OPERATING A MOBILE COMMUNICATION DEVICE IN EITHER A HANDSET MODE OR SPEAKERPHONE MODE

(71) Applicant: Matt J. INGALLS, Oakland, CA (US)

(72) Inventor: Matt J. INGALLS, Oakland, CA (US)

(73) Assignee: VOXER IP LLC, San Francisco, CA (US)

(21) Appl. No.: 13/438,768

(22) Filed: Apr. 3, 2012

(51) Int. Cl. H04W 88/02

(52) U.S. Cl. 455/566; 455/569.1

(57) ABSTRACT

A proximity sensor system for use with mobile communication devices that reduces the incidence of false positives. The proximity sensor system includes a first sensor and a second sensor, each of which are configured to separately generate outputs indicative if the mobile communication device should operate in a handset mode or a speakerphone mode. The system further includes a processor configured to switch the operation of the mobile communication device between the handset mode and the speakerphone mode when both outputs indicate that the mobile communication device should be in one mode or the other. By relying on both first and second sensors, the incidence of false positives is reduced. In various alternative embodiments, multiple first sensors and/or second sensors may be used.

### BACKGROUND

1. Field of the Invention

The present invention generally relates to mobile communication devices, and more particularly, to a proximity detection system for mobile communication devices that reduces the incidence of “false positives” when switching between the speakerphone mode and the handset mode.

2. Description of Related Art

Many mobile communication devices, such as smart phones, are capable of operating in either a handset mode or a speakerphone mode. The handset mode is used when a user holds the phone in contact with or adjacent to their ear. In this mode, an internal speaker near the user's ear is activated. In the speakerphone mode, the internal speaker is deactivated while a loudspeaker is activated, freeing the user to use the phone without having to hold it next to their ear. A proximity sensor, built into the phone, is used to automatically switch between the two modes, depending on the position of the phone relative to the user.

One known proximity sensor for mobile phones is described in U.S. Patent Publication 2010/0080084. In this example, a signal processor is used to perform spectral analysis of the frequency signals picked up by two microphones located on the mobile phone. The proximity detector determines if the phone is being held either adjacent to the ear of the user or away from the user, depending on the frequency of the received signals. If the proximity detector determines that the phone is being held close to the user's ear, then the phone is switched to the handset mode. Otherwise, the phone operates in the speakerphone mode.

The problem with the above-described proximity detector is that it relies on only a single sensor to determine the position of the phone. As a result, the phone is susceptible to “false positives”, which may be caused by a variety of factors. For example, ambient noise, different frequencies in the speech patterns of a given user, or that fact that different users all speak at different frequencies, may all contribute to the proximity detector making the wrong decision and operating the phone in the incorrect mode.

### SUMMARY OF THE INVENTION

The present invention pertains to a proximity sensor system for use with mobile communication devices that reduces the incidence of false positives. The proximity sensor system includes a first sensor and a second sensor, each of which are configured to separately generate outputs indicative if the mobile communication device should operate in a handset mode or a speakerphone mode. The system further includes a processor configured to switch the operation of the mobile communication device between the handset mode and the speakerphone mode when both outputs indicate that the mobile communication device should be in one mode or the other. By relying on both first and second sensors, the incidence of false positives is reduced. In various alternative embodiments, multiple first sensors and/or second sensors may be used.

### BRIEF DESCRIPTION OF THE DRAWINGS

The invention may best be understood by reference to the following description taken in conjunction with the accompanying drawings, which illustrate specific embodiments of the invention.

FIGS. 1A and 1B are diagrams of a mobile communication device embodying the principles of the present invention.

FIG. 2 is a block diagram of a non-exclusive proximity sensor system embodying the principles of the present invention for use in the mobile communication device.

FIG. 3 is a flow diagram illustrating a non-exclusive embodiment of the operation of the proximity sensor system in accordance with the principles of the present invention.

FIGS. 4A and 4B illustrate the mobile communication device in use in accordance with the principles of the present invention.

FIG. 5 is a flow diagram illustrating another non-exclusive embodiment of the operation of the proximity sensor system in accordance with the principles of the present invention.

It should be noted that like reference numbers refer to like elements in the figures.

The above-listed figures are illustrative and are provided as merely examples of embodiments for implementing the various principles and features of the present invention. It should be understood that the features and principles of the present invention may be implemented in a variety of other embodiments and the specific embodiments as illustrated in the Figures should in no way be construed as limiting the scope of the invention.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

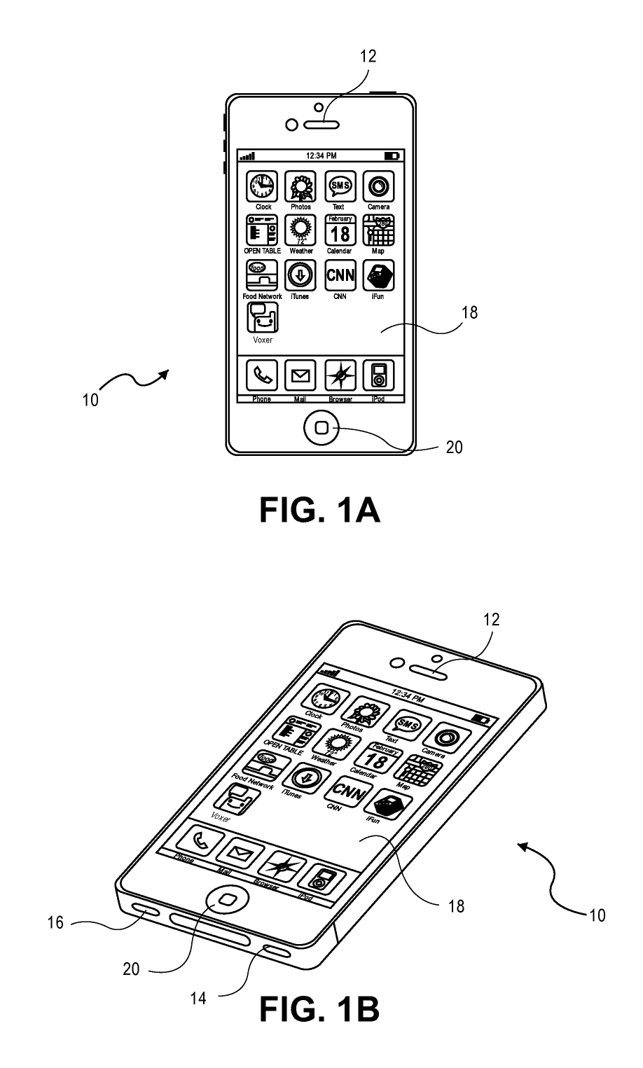

Referring to FIGS. 1A and 1B, a communication device 10 embodying the principles of the present invention is shown. The communication device 10 includes an internal speaker 12, a loudspeaker 14, a microphone 16, a touch-sensitive display 18, and a home button 20. The communication device 10 is capable of operating in either a handset mode or a speakerphone mode. In the handset mode, the internal speaker 12 is activated. Alternatively, in the speakerphone mode, internal speaker 12 is deactivated, while audio is played through the loudspeaker 14. In the embodiment illustrated, the microphone 16 is shared by and used during both the handset and speakerphone modes. In alternative embodiments, separate microphones (not illustrated) may be used for each mode.

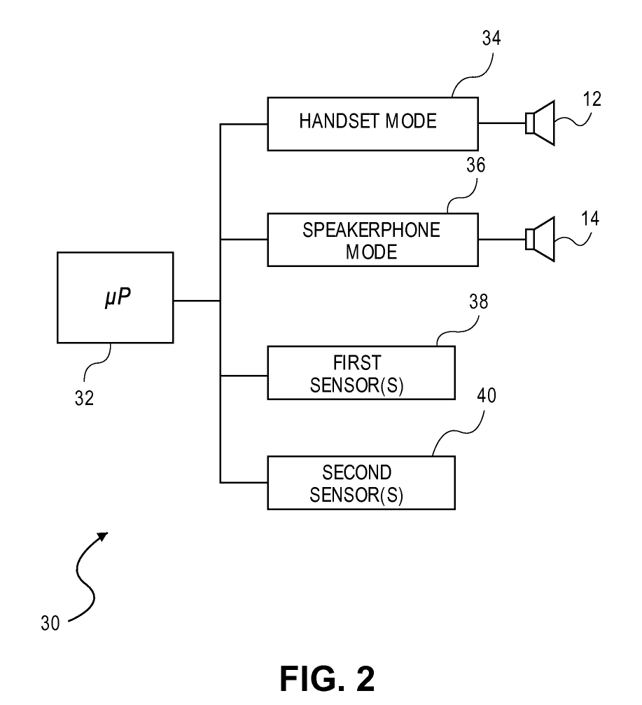

Referring to FIG. 2, a block diagram of a non-exclusive embodiment of a proximity sensor system 30 used for switching between a handset mode and a speakerphone mode on the mobile communication system 10 is illustrated. The proximity sensor system 30 includes a processor 32, a handset mode element 34 for activating internal speaker 12 when the handset mode is implement and a speakerphone mode element 36 for activating loudspeaker 14 when the speakerphone mode is implemented. In various embodiments, the handset mode element 34 and the speakerphone mode element 36 may each be implemented in hardware, software, firmware, or any combination thereof, and each includes the appropriate drivers and circuitry, as is well known in the art, to selectively activate speakers 12 and 14 respectively.

The proximity sensor system 30 also includes one or more first sensors 38. In various embodiments, the one or more first sensors 38 may include either an active or passive infrared sensor, a signal processor, or, any other type of first sensor, or any combination thereof. For example, an passive infrared sensor 38 will detect an increase in heat or less light when the communication device 10 is placed in contact with or adjacent to the face and ear of a user. Active infrared sensors, in comparison, detect proximity by generating and receiving an energy signal or pulse that is reflected off the face or ear of the user. Regardless of the type used, the first sensor will indicate that the communication device is in close proximity with the user and the handset mode should be activated. Otherwise, the speakerphone mode is activated. Alternatively, as noted in the aforementioned 2010/0080084 Publication, the first sensor 38 may be a signal processor that analyzes the frequency or speech detected by one or more microphones 16 on the communication device 10 to indicate if the handset or speakerphone modes should be implemented. Although examples of several specific first sensors are provided, it should be noted that any type of first sensor could be used.

The proximity sensor system 30 further includes one or more second sensors 40. The one or more second sensors 40 may include a gyroscope, a motion sensor, a sensor built into touch screen 18, or any combination thereof. With a gyroscope, the orientation of the communication device 10 is calculated and used to indicate or determine if the handset mode or the speakerphone mode should be implemented. Several examples of the gyroscope calculating and indicating if either the handset or speakerphone mode should be implemented include (i) when the communication device 10 is in a horizontal or near horizontal orientation, it is assumed that the device 10 is resting on a table or other flat surface and should be in the speakerphone mode; (ii) alternatively, when in a vertical or near vertical orientation, it is assumed that the communication device 10 is being held adjacent to or in contact with the ear and face of the user and should be in the handset mode; and (iii) if the communication device is rotated about the Y-axis, as if the user is positioning the communication device from the front of their face to their ear, the orientation is indicative of the handset mode.

With a motion sensor, a certain range of motion or motions may be used to indicate if the communication device 10 should be in the handset or speakerphone modes. For example, an upward motion may assume the device 10 is being positioned adjacent the user's ear, indicating that the handset mode should be activated, while a downward motion indicates that the speakerphone mode should be implemented. Certain motions, however, may be outside an acceptable range of motions. For example, a sudden downward motion, for example when the communication device 10 is accidently dropped, may be ignored and not used by the proximity sensor 30.

In yet another example, a sensor built into display 18 may be used by the system 30. When the indicates that the display 18 is contact with or adjacent to the user's face, it indicates that the handset mode should be implemented. In various embodiments, the detection element within the screen 18 can rely on capacitance, resistance, or heat. Although examples of several specific second sensors 40 are provided, it should be noted that any type of second sensor could be used.

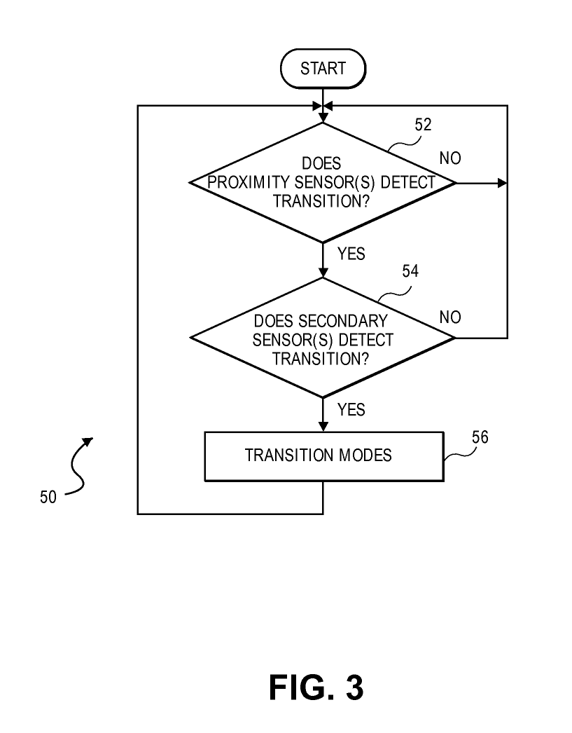

Referring to FIG. 3, a flow diagram 50 illustrating a non-exclusive embodiment of the operation of the proximity sensor system 30 is illustrated. In the decision step 52, the first sensor or sensors 38 are continually monitored by processor 32 to determine if a transition from the current mode to the other mode should occur. In decision step 54, the second sensor or sensors 40 are also continually monitored by processor 32 to determine if a transition from the current mode to the other mode should occur. If both the one or more first sensors 38 and the one or more second sensors 40 do not detect a transition, than the processor 32 maintains the current mode. If the first sensor or sensors 38 detect a transition, but the second sensor or sensors 40 do not, or vice versa, then the processor 32 maintains the current mode. The processor 32 transitions the mode (step 56) only when both the one or more first sensors 38 and the one or more second sensors 40 indicate that a transition should be made. For example, if the one or more first sensors 38 and the one or more second sensors 40 each indicate that a transition from the speakerphone mode to the handset mode should be made, then the processor 32 will deactivate speakerphone mode element 36 and speaker 14, and activate the handset mode element 34 and speaker 12. Alternatively, when the opposite transition occurs, then the processor 32 activates speakerphone mode element 34 and speaker 14, while deactivating handset mode element 34 and speaker 12.

Again, it should be noted, that the number of first sensors 38 and/or the number of second sensors 40 used in proximity sensor system 30 may vary. At a minimum, one first sensor 38 and one second sensor 40 are used. In other non-exclusive embodiments, more than one first sensor 38 and/or more than one second sensor 40 may be used. As a general rule, the more first sensors 38 and second sensors 40 that are used, the fewer false positives are likely to occur.

It is further noted that the present invention should not be limited to the specific examples of first sensors and second sensors as described herein. For example, the specific types of first sensors as discussed herein could be used as second sensors or vice versa. As already noted, the present invention contemplates that any type of first and second type sensors may be used.

It also should be noted that functionality of the handset mode element 34 and speakerphone element 36 optionally includes functionality beyond simply activating or deactivating internal speaker 12 and loudspeaker 14 respectively. For example, each element 34 and 36 may also be responsible for either activating or deactivating a host of other functions and elements on the communication device 10. For example, the touch screen display 18 may be deactivated during the handset mode, and activated during the loudspeaker mode. Other functions and/or elements that may be selectively activated or deactivated may include microphones, cameras, graphic user interface functions, audio functions, etc.

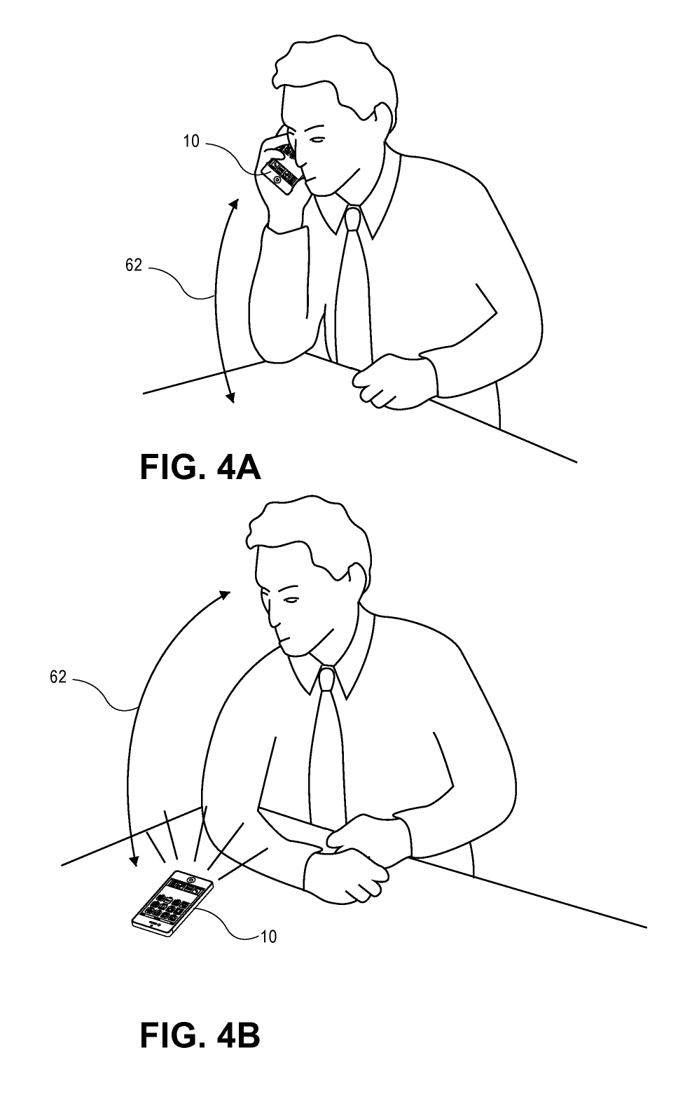

Referring to FIGS. 4A and 4B, the communication device 10, including the proximity detection system 30, is illustrated in use. In FIG. 4A, the handset mode is selected because the one or more first sensors 38 and the one or more second sensors 40 indicate that the communication device 10 has been moved, is vertically oriented and rotated in a position adjacent to or in contact with the user's face and ear. In FIG. 4B, the device 10 is operating in the speakerphone mode because the one or more first sensors 38 and second sensors 40 indicate that the device 10 has been moved downward, away from the user, and is orientated on a horizontal or flat surface. As the communication device 10 is moved between the two positions, as represented by the arrow 62, the device switches between the two modes as described herein.

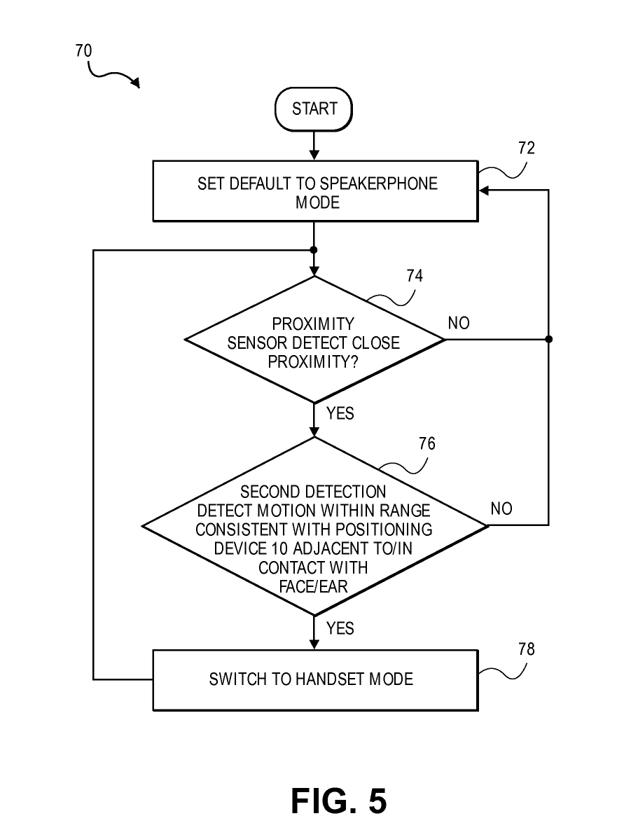

Referring to FIG. 5, a flow diagram 70 illustrating another non-exclusive embodiment of the operation of the proximity sensor system 30 in accordance with the principles of the present invention is shown. With this embodiment, the default mode for the communication device 10 is set to the speakerphone mode in step 72. In decision step 74, the output of a proximity sensor is monitored. When the proximity sensor detects that the communication device 10 is not in close proximity to the user, then the communication device 10 remains in the default speakerphone mode. On the other hand, if the proximity sensor determines that the communication device 10 has been positioned within close proximity of the user, for example when positioned in contact with or adjacent to the face and/or ear of the user, then the output of a second sensor is considered in decision step 76. The second sensor is used to determine if the communication device 10 is or has been moved within a range of motions consistent with positioning the device 10 adjacent to or in contact with the ear and/or face of the user. If the output of the second sensor does not detect motion within the range, then the processor 32 of the proximity system 30 maintains the communication device 10 in the default speakerphone mode. On the other hand, if the movement is within the range, then the processor 32 switches the device 10 to the handset mode is step 78. With this arrangement, the system 30 maintains the communication device 10 in the handset mode only when both sensors indicate that the mode should be switched from the default speakerphone mode. Otherwise, the speakerphone mode is maintained.

In variations of the above-described embodiment, it should be noted that the default mode does not necessarily have to be set to the speakerphone mode. On the contrary, the default mode can be the handset mode with the system 30 switching over to the speakerphone mode when the decision steps 72, 74 indicate that a mode transition should occur. In addition, the embodiment of FIG. 5 contemplates that any type of proximity sensor capable of determining if the device 10 is positioned in contact with or adjacent to the ear and/or face of the user may be used and any type of second sensor for detecting motion within the consistent range, such as any of those previously described herein, may be used.

Although the communication device 10 as illustrated herein resembles an iPhone from Apple, in no way should these figures be construed as limiting the scope of the present invention. On the contrary, the proximity detection system 30 may be used in any mobile communication device or platform. For example, the system 30 may be implemented and used in any cellular phone, mobile phone, smart phone, radio, walkie talkie, or mobile computing device, including but not limited to, tablets or laptop computers.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and methods and should not be restricted to the ones mentioned above. It is therefore intended that the invention be interpreted to include all variations and equivalents that fall within the true spirit and scope of the invention.

What is claimed is:

1. A mobile communication device, comprising:
a first sensor configured to generate a first output indicative if the mobile communication device should operate in a handset mode or a speakerphone;
a second sensor configured to generate a second output indicative if the mobile communication device should operate in the handset mode or the speakerphone mode; and
a processor configured to switch the operation of the mobile communication device between:
(i) the handset mode when both the first output and the second output indicate that the mobile communication device should be in the handset mode; and
(ii) the speakerphone mode when both the first output and the second output indicate that the mobile communication device should be in the speakerphone mode.

2. The device of claim 1, wherein the first sensor is an infrared sensor.

3. The device of claim 1, wherein the first sensor is a signal processor, the signal processor configured to generate the first output to indicate the position of the mobile communication device relative to a user based on signals derived from a microphone provided on the communication device.

4. The device of claim 1, further comprising two or more first sensors working in cooperation to indicate if the mobile communication device should operate in the handset mode or the speakerphone mode based on the proximity of the mobile communication device relative to a user.

5. The device of claim 1, wherein the second sensor is a measuring device configured to generate the second output, the second output determining the orientation of the mobile communication device.

6. The device of claim 1, wherein the second sensor is a gyroscope.

7. The device of claim 1, wherein the second sensor is a display screen sensor configured to generate the second output, the second output indicating the proximity of a display screen on the mobile communication device relative to a user of the communication device.

8. The device of claim 1, wherein the display screen sensor comprises one of the following:
(i) a capacitance screen detector;
(ii) a resistance screen detector; or
(iii) a heat detecting sensor.

9. The device of claim 1, wherein the second sensor is a motion sensor.

10. The device of claim 1, wherein the second sensor is a motion sensor configured to generate the second output, the second output indicative of motion of the communication device either in the direction toward or away from a user of the communication device.

11. The device of claim 1, wherein the second sensor is a motion sensor configured to generate the second output, the second output indicative of the motions of the communication device within an acceptable range of motions.

12. The device of claim 1, further comprising two or more second sensors working in cooperation to indicate if the mobile communication device should operate in the handset mode or the speakerphone mode based on the proximity of the mobile communication device relative to a user.

13. The device of claim 1, wherein the second sensor is a gyroscope.

14. A communication device, comprising:
a proximity sensor configured to generate a first output indicative of the communication device being positioned in proximity to the face and/or ear of a user;
a second sensor configured to generate a second output indicative of the communication device being moved within a range of motion consistent with placement of the communication device in proximity to the face and/or ear of the user; and
a processor configured to receive the first output and the second output and to place the communication device in a handset mode when both the first and the second outputs indicate the that communication device is in proximity to the face and/or ear of the user.

15. The device of claim 14, wherein the processor is further configured to place the communication device in a speakerphone mode when either the first output or the second output is indicative of the communication device not in proximity to the face and/or ear of the user.

16. The device of claim 14, wherein the processor is further configured to place the communication device in a speakerphone mode when both the first output and the second output are indicative of the communication device not in proximity to the face and/or ear of the user.

17. The device of claim 14, wherein the handset mode is a default mode for the communication device.

18. The device of claim 14, wherein a speakerphone mode is a default mode for the communication device.

19. The device of claim 14, wherein the proximity sensor is an infrared sensor, the infrared sensor configured to generate the first output to indicate the position of the communication device relative to the face/ear of the user based on reflected infrared energy.

20. The device of claim 14, wherein the proximity sensor is a signal processor, the signal processor configured to generate the first output to indicate the position of the communication device relative to the face/ear of the user based on signals derived from a microphone provided on the communication device.

21. The device of claim 14, wherein the second sensor is a display screen sensor configured to generate the second output, the second output indicating the proximity of a display screen on the communication device relative to the face/ear of the user.

22. The device of claim 21, wherein the display screen sensor comprises one of the following:
(i) a capacitance screen detector;
(ii) a resistance screen detector; or
(iii) a heat detecting sensor.

23. The device of claim 14, wherein the second sensor is a motion sensor.

24. The device of claim 14, wherein the second sensor is a gyroscope.
